(19) United States
(12) Patent Application Publication
(10) Pub. No.: US 2026/0072131 A1
(43) Pub. Date: Mar. 12, 2026

(54) SYSTEMS AND METHODS FOR RAPID RADAR MISALIGNMENT MONITORING

(71) Applicant: Torc Robotics, Inc., Blacksburg, VA (US)

(72) Inventors: Vicent Rodrigo Marco, Stuttgart (DE); Joseph Wade Foster, Arlington, VA (US); Matthew Marti, Blacksburg, VA (US); Marco Busch, Muenchen (DE); Rubing Wang, Stuttgart (DE)

(21) Appl. No.: 18/883,705

(22) Filed: Sep. 12, 2024

(51) Int. Cl. G01S 7/40; G01S 13/58; G01S 13/931

(52) U.S. Cl. CPC G01S 7/40; G01S 13/58; G01S 13/931

(57) ABSTRACT

A system for monitoring radar misalignment on an autonomous vehicle is provided. The system includes a radar sensor configured to capture sensor data. The radar sensor is disposed on an autonomous vehicle traveling along a trajectory. The system also includes an autonomy computing system comprising a processor and a memory storing computer executable instructions. The processor, upon executing the computer executable instructions, configured to: generate a radar coordinate system from the sensor data, identify a static object from the sensor data, compute a vehicle coordinate system based on the static object. The system further includes computing a misalignment between the radar coordinate system and the vehicle coordinate system based on a comparison of an orientation of the radar coordinate system and an orientation of the vehicle coordinate system, and generate a sensor data transformation to align the sensor data to the vehicle coordinate system.

### TECHNICAL FIELD

The field of the disclosure relates generally to operation of autonomous vehicles and, more specifically, monitoring and aligning radar sensors on an autonomous vehicle.

### BACKGROUND OF THE INVENTION

Effective radar sensor alignment is needed for the operation of autonomous vehicles, which depend on relatively accurate data from sensors to detect obstacles and maintain safe navigation, particularly for key functions within an automated driving system, such as motion estimation, localization, or environment recognition.

Vehicle assembly techniques generally allow for certain tolerances that may lead to errors in orientations of vehicle sensors. Additionally, during operation, an orientation of sensors may be altered due to wear, vibrations, or physical damage. These orientation errors deteriorate the performance of autonomous driving systems that utilize data generated by these sensors. A system capable of identifying and correcting such orientation errors is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a computer-implemented method for detecting misalignment of a radar sensor of an autonomous vehicle is provided. The computer-implemented method includes receiving sensor data from a radar sensor disposed on an autonomous vehicle travelling along a trajectory; identifying a static object based on the sensor data; estimating a 3D radar velocity of the autonomous vehicle based on the sensor data, the 3D radar velocity expressed in a radar coordinate system; computing a 3D vehicle velocity in a vehicle coordinate system based on a radar-to-vehicle orientation and the 3D radar velocity; comparing the 3D vehicle velocity to a longitudinal axis of the autonomous vehicle; detecting a misalignment of the radar sensor based on the comparison; and controlling operation of the autonomous vehicle based on the detected misalignment.

In another aspect, an autonomous vehicle is provided. The autonomous vehicle includes a radar sensor configured to capture sensor data, the radar sensor disposed on the autonomous vehicle traveling along a trajectory. The autonomous vehicle further includes a misalignment determination computing device may include at least one processor coupled to a memory device storing computer executable instructions, the at least one processor, upon executing the computer executable instructions, programmed to: identify a static object based on the sensor data, estimate a 3D radar velocity of the autonomous vehicle based on the sensor data, the 3D radar velocity expressed in a radar coordinate system, compute a 3D vehicle velocity in a vehicle coordinate system based on a radar-to-vehicle orientation and the 3D radar velocity, compare the 3D vehicle velocity to a longitudinal axis of the autonomous vehicle, detect a misalignment of the radar sensor based on the comparison, and control operation of the autonomous vehicle based on the detected misalignment.

In yet another aspect, an autonomy computing system for an autonomous vehicle is provided. The autonomy computing system includes a radar sensor disposed on an autonomous vehicle. The system also includes a misalignment determination computing device may include at least one processor coupled to a memory device storing computer executable instructions, the at least one processor, upon executing the computer executable instructions, programmed to: receive sensor data from the radar sensor disposed on the autonomous vehicle travelling along a trajectory, identify a static object based on the sensor data, estimate a 3D radar velocity of the autonomous vehicle based on the sensor data, the 3D radar velocity expressed in a radar coordinate system, compute a 3D vehicle velocity in a vehicle coordinate system based on a radar-to-vehicle orientation and the 3D radar velocity, compare the 3D vehicle velocity to a longitudinal axis of the autonomous vehicle, detect a misalignment of the radar sensor based on the comparison, and control the operation of the autonomous vehicle based on the detected misalignment.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 illustrates an example process of detecting misalignment of the radar sensor;

FIG. 4 is a flow diagram of an example method of monitoring radar misalignment and;

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The present disclosure is directed to autonomous vehicles and control thereof by detecting misalignment of radar sensors. The present disclosure detects a radar sensor misalignment by comparing a velocity measured by a radar sensor to the longitudinal axis of the autonomous vehicle to detect the misalignment. It is needed that the sensors are aligned for safe operation of the autonomous vehicle. Conventionally, measurements from sensors of different modalities are processed to detect a discrepancy between the measurements in the radar sensors, which is then attributed to a potential sensor misalignment among other possible issues. However, the conventional solution requires sensors of different modalities can perceive the same environment features as radar sensors. This premise does not always hold. The convention solution requires processing of sensor data from multiple sensors that utilize the limited computing resources on the autonomous vehicle. Further, aligning data from different sensors are difficult and computationally heavy. Accordingly, the present disclosure provides improved systems and methods for detecting sensor misalignment the requires fewer computing resources on the autonomous vehicle by only using sensor data from the radar sensor.

In traditional methods of detecting misalignment of radar sensors, predefined target object with well-defined shapes and positions is relied on in determining misalignment of radar sensors. The approaches demand dedicated infrastructure and significant time and computation in the calibration procedure. In some conventional methods, detecting radar misalignment relies on high-definition digital maps and radar-sensitive structural elements to identify extrinsic parameters of the radar sensor. High-definition maps and environments rich in high radar-sensitive structural elements, however, are not always available. In contrast, systems and methods described herein require neither, thereby increasing availability of monitoring misalignment of radar sensors. The disclosed systems and methods merely utilize the motion of the autonomous vehicle and radar measurements for static objects surrounding the autonomous vehicle and using the longitudinal axis of the autonomous vehicle in determining misalignment. The systems and methods described herein do not rely on dedicated infrastructure or equipment, and the computation load is significantly reduced, thereby facilitating implementation of the systems and methods online, where the detection of misalignment is provided while the autonomous vehicle is in operation.

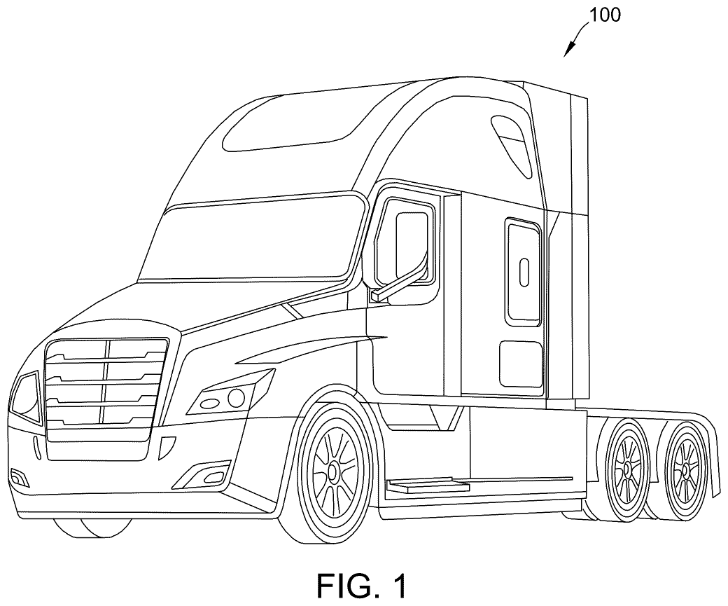

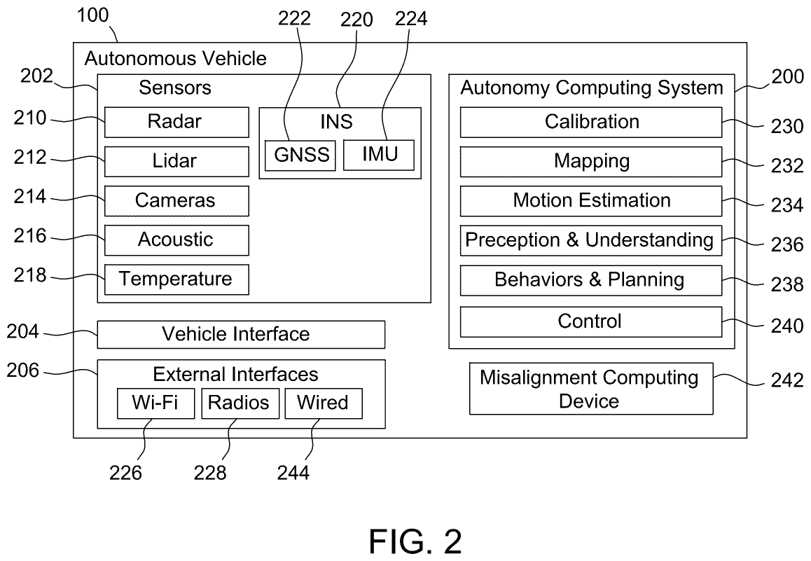

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5 g, Bluetooth, etc.).

In various embodiments, the autonomous vehicle 100 includes a misalignment computing device 242. In some embodiments, the misalignment computing device 242 includes a computing device such as shown in FIG. 6 (described later). The misalignment computing device 242 may be a part of the autonomy computing system 200. In other embodiments, the misalignment computing device 242 is an independent computing device separate from the autonomy computing system 200. The misalignment computing device 242 is programmed to receive sensor data from a radar sensor 210 on the autonomous vehicle 100 to detect a misalignment of a radar sensor 210. The misalignment computing device 242 identifies a static object based on the sensor data and estimates a 3D radar velocity of the autonomous vehicle 100. The misalignment computing device 242 computes a 3D vehicle velocity based on a radar-to-vehicle orientation and the 3D radar velocity. The misalignment computing device 242 compares the computed 3D vehicle velocity to a longitudinal axis of the autonomous vehicle to detect a misalignment of the radar sensor 210.

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

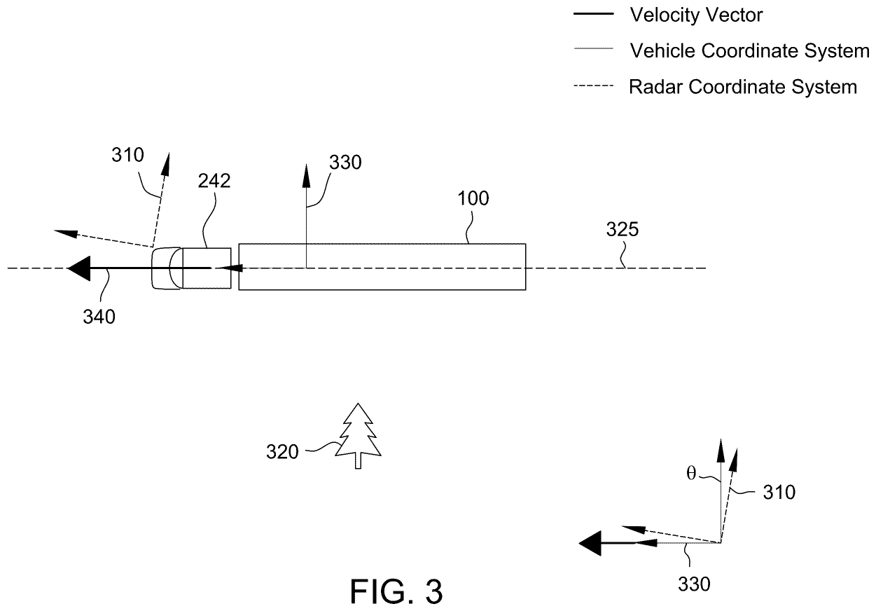

FIG. 3 illustrates an example process detecting misalignment of the radar sensor. Referring to autonomous vehicle 100 shown in FIGS. 1 and 2, FIG. 3 shows autonomous vehicle 100 traveling along a trajectory. For example, the autonomous vehicle 100 is travelling within a lane along a relatively straight road, such as a highway. In some embodiments, the misalignment computing device 242 is configured to determine the autonomous vehicle 100 is not turning based on the trajectory of the autonomous vehicle 100 and initiate detecting misalignment of the radar sensor 210 based on the determination that the autonomous vehicle 100 is not turning. As used herein, a vehicle is not turning when the vehicle is traveling along a lane of a relatively straight road, such as a highway. The autonomous vehicle 100 includes a radar sensor 210 disposed on the autonomous vehicle 100 configured to capture sensor data representing the environment surrounding the autonomous vehicle 100. The autonomous vehicle 100 includes a misalignment computing device 242 configured to receive the sensor data from the sensor 202. The misalignment computing device 242 may be a part of the autonomy computing system 200. In some embodiments, the misalignment computing device 242 may be a separate computing device that is coupled to the autonomy computing system 200.

The misalignment computing device 242 includes a memory device coupled to a processor programmed to identify a static object 320 based on the sensor data. The misalignment computing device 242 estimates a radar velocity of the autonomous vehicle 100. A radar velocity is a velocity of the vehicle in the radar coordinate system 310. The radar velocity may be 3D. In one example, the radar sensor 210 measures the change in position of the static object 320 relative to the autonomous vehicle 100 over a time interval to estimate the radar velocity. In another example, the radar velocity of may be estimated based on doppler velocities of the autonomous vehicle 100 with respect to the static object 320 determined based on the radar data. As used herein, the radar coordinate system 310 refers to a coordinate system for determining a position of a point in space based on the radar sensor 210. The radar sensor 210 may be the origin of the radar coordinate system. One of the axes of the radar coordinate system 301 may correspond to the orientation of the radar sensor 210.

The misalignment computing device 242 is further configured to compute a vehicle velocity of the autonomous vehicle 100. A vehicle velocity is a velocity of the vehicle in the vehicle coordinate system 330. A vehicle velocity may be 3D. As used herein, the vehicle coordinate system 330 refers to a coordinate system for determining a position of a point in space based on the autonomous vehicle 100. The autonomous vehicle 100 may be the origin of the radar coordinate system. One of the axes of the vehicle coordinate system 310 may correspond to the longitudinal axis 325 of the autonomous vehicle 100. The vehicle velocity is computed based on the 3D radar velocity and a radar-to-vehicle orientation between the radar sensor 210 and the autonomous vehicle 100. A radar-to-vehicle orientation is the orientation between the radar sensor 210 and the autonomous vehicle 100. A predefined radar-to-vehicle orientation may be used. A predefined radar-to-vehicle orientation may be determined during fabrication and assembling of the radar sensor 210 with the autonomous vehicle 100, or during calibration and recalibration of the radar sensor 210 before, during, or after the autonomous vehicle 100 is in operation. The vehicle velocity may be computed by transforming the radar velocity based on the radar-to-vehicle orientation. In one example, the vehicle velocity is computed by rotating the radar velocity by an angle of a negative of the radar-to-vehicle orientation. For example, if the radar sensor 210 has an angle of θ relative to the autonomous vehicle, the vehicle velocity is computed by rotating the radar velocity by an angle of −θ (see FIG. 3). A positive angle is in the clock-wise direction. The misalignment computing device 242 then compares the vehicle velocity to the longitudinal axis 325 of the autonomous vehicle 100. When the autonomous vehicle is not turning, the vehicle velocity should be aligned with the longitudinal axis 325 if the radar sensor 210 is aligned or has not changed from the radar-to-vehicle orientation. The misalignment computing device 242 is configured to detect a misalignment of the radar sensor 210 based on the comparison of the vehicle velocity to the longitudinal axis 325 of the autonomous vehicle 100. In one example, an estimator, such as a Kalman filter or a recursive least square estimator, may be used to estimate the angle of the vehicle velocity relative to longitudinal axis xxx or the misalignment. If the vehicle velocity is not aligned with the longitudinal axis 325, the radar sensor 210 is misaligned or has deviated from the radar-to-vehicle orientation. Determination of misalignment may be based on a threshold. For example, if the angular difference between the vehicle velocity and the longitudinal axis 325 is below the threshold, misalignment is not indicated. If the angular difference is at or above a threshold, misalignment is indicated. The threshold may be predefined or adjusted. Sensor data from a misaligned radar sensor 210 introduce errors in the downstream process and analysis of the data. For example, the autonomy computing system 200 may erroneously determine that an actor is in the next lane is not in the next lane based on misaligned radar data. The misalignment computing device 242 detects the misalignment based on sensor data only from the radar sensor 210. Detecting misalignment based on sensor data only from the radar sensor 210 is advantageous in reducing computation load on the autonomous vehicle 100 and increasing the speed of the determination. Complicated and difficult problems of feature extraction and matching between different sensors in using sensor data from different sensors are non-existent. Because the reduced computation load and demand, detecting misalignment does not pose as a burden to the computation resources of the autonomous vehicle 100. In some embodiments, the misalignment computing device 242 detects the misalignment while the autonomous vehicle 100 is in operation.

In some embodiments, the misalignment computing device 242 may compute a confidence level of the detected misalignment. The confidence level may be a variance of the detected misalignment. In some embodiments, the misalignment computing device 242 may correct the misalignment in the sensor data based on an angle between the vehicle velocity and the longitudinal axis 325 based on the computed confidence level. For example, the confidence level being relatively high, e.g., being at or above a threshold, may indicate that the estimated misalignment is consistent across the estimates, and the radar sensor 210 is relatively stable and secured with the autonomous vehicle but has deviated from the radar-to-vehicle orientation. Correction therefore is applied. The correction includes applying a transformation to the radar sensor 210 data to correct for the misalignment or the angle between the computed vehicle velocity and the longitudinal axis 325 of the autonomous vehicle 100. In some embodiments, if the confidence level is at or above a threshold, the radar-to-vehicle orientation may be updated based on the detected misalignment. For example, the radar-to-vehicle orientation is updated by adding the detected misalignment to the radar-to-vehicle orientation. If the confidence level is relatively low, e.g., being below a threshold, it may be indicated that misalignment is inconsistent from one estimate to another estimate, and the radar sensor 210 may be loose from the autonomous vehicle or malfunctioning. Correction is not applied. Instead, maintenance may be needed.

In some embodiments, the misalignment computing device 242 controls the operation of the autonomous vehicle 100 based on the detected misalignment. For example, the misalignment computing device 242 may transmit an indicator of the misalignment to a perception module 236 of the autonomy computing system 200. The indicator may correspond to the detection of the misalignment between the radar sensor 210 and the longitudinal axis 325 of the autonomous vehicle 100. The indicator may include the misalignment. The indicator may also include the confidence level. In some embodiments, the autonomy computing system 200 will process the indicator and adjust the operation of the autonomous vehicle 100 to compensate for the misaligned radar sensor 210. For example, if the confidence level is relatively high (e.g., at or above a threshold), the radar data remains reliable after correction. If the confidence level is relatively low (e.g., below a threshold), the radar data are unreliable and the autonomy computing system 200 may exclude data from the radar sensor 210 when operating the autonomous vehicle 100 until maintenance has been performed on the radar sensor 210, such as securing the radar sensor 210 or replacing the radar sensor 210.

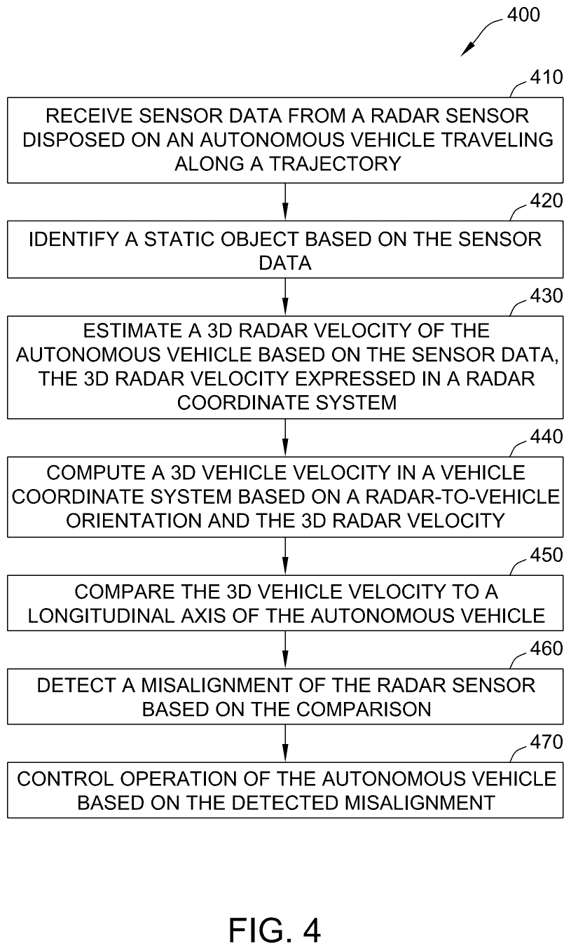

FIG. 4 illustrates a method 400 for radar misalignment monitoring. Method 400 starts by receiving 410 sensor data from a radar sensor 210. In various embodiments, the radar sensor 210 is disposed on an autonomous vehicle 100 travelling along a trajectory. Method 400 also includes identifying 420 a static object based on the sensor data. Method 400 further includes estimating 430 a radar velocity of the autonomous vehicle 100 based on the sensor data. The radar velocity is expressed in a radar coordinate system. Method 400 also includes computing 440 a vehicle velocity in a vehicle coordinate system based on a radar-to-vehicle orientation and the radar velocity. Method 400 may include determining the autonomous vehicle 100 is not turning based on the trajectory of the autonomous vehicle 100 and initiating the computing 440 of the vehicle velocity based on the trajectory determination. Turning of the autonomous vehicle introduces errors in the detection of misalignment. If the autonomous vehicle 100 is turning, the vehicle velocity is not computed and misalignment is not determined. Further, method 400 includes comparing 450 the vehicle velocity to a longitudinal axis 325 of the autonomous vehicle. Method 400 also includes detecting 460 a misalignment of the radar sensor 210 based on the comparison. In some embodiments, detecting 460 the misalignment is based on sensor data only from the radar sensor 210. The detection 460 of the misalignment may occur when the autonomous vehicle 100 is in operation. In various embodiments, method 400 includes controlling operation of the autonomous vehicle 100 based on the detected misalignment. Method 400 may further include transmitting an indicator of the misalignment to a perception module of an autonomy computing system of the autonomous vehicle 100. Further, method 400 may include computing a confidence level of the detected misalignment and correcting the misalignment in the sensor data based on an angle between the vehicle velocity and the longitudinal axis 325. Method 400 may include additional or fewer steps.

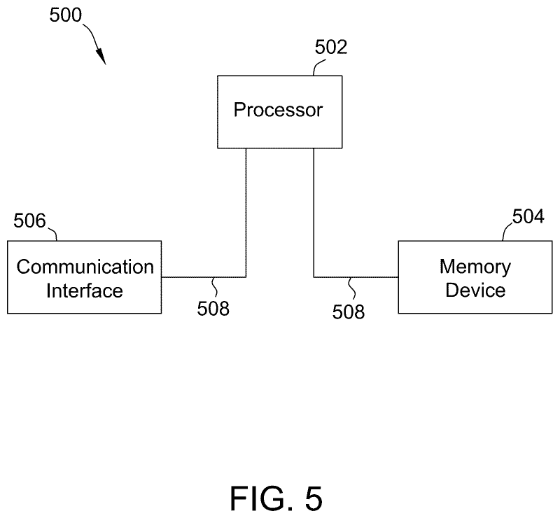

FIG. 5 is a block diagram of an example computing device 500. In various embodiments, autonomy computing system 200 and/or misalignment computing device 242 may be implemented using one or more example computing devices 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) enabling identification of misaligned sensors of a vehicle by computing a predicted velocity vector based on data received from the sensor and comparing the data to the longitudinal axis of the autonomous vehicle during a known direction of motion of the (b) enabling identification of misaligned sensors of an autonomous vehicle while the autonomous vehicle operates, or (c) improving operation of an autonomous vehicle by correcting data received from misaligned sensors of the autonomous vehicle based on a comparison between a computed velocity vector and the longitudinal axis of the autonomous vehicle during a known direction of motion.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A computer-implemented method for detecting misalignment of a radar sensor of an autonomous vehicle, the method comprising:
receiving sensor data from a radar sensor disposed on an autonomous vehicle travelling along a trajectory;
identifying a static object based on the sensor data;
estimating a 3D radar velocity of the autonomous vehicle based on the sensor data, the 3D radar velocity expressed in a radar coordinate system;
computing a 3D vehicle velocity in a vehicle coordinate system based on a radar-to-vehicle orientation and the 3D radar velocity;
comparing the 3D vehicle velocity to a longitudinal axis of the autonomous vehicle;
detecting a misalignment of the radar sensor based on the comparison; and
controlling operation of the autonomous vehicle based on the detected misalignment.

2. The method of claim 1, wherein detecting the misalignment is based on sensor data only from the radar sensor.

3. The method of claim 1, wherein detecting the misalignment occurs while the autonomous vehicle is in operation.

4. The method of claim 1, further comprising transmitting an indicator of the misalignment to a perception module of an autonomy computing system of the autonomous vehicle.

5. The method of claim 1 further comprising:
determining the autonomous vehicle is not turning based on the trajectory; and
initiating the computing of the 3D vehicle velocity based on the determination.

6. The method of claim 1 further comprising computing a confidence level of the detected misalignment.

7. The method of claim 6, further comprising correcting the misalignment in the sensor data based on an angle between the 3D vehicle velocity and the longitudinal axis based on the confidence level.

8. An autonomous vehicle comprising:
a radar sensor configured to capture sensor data, the radar sensor disposed on an autonomous vehicle traveling along a trajectory; and
a misalignment determination computing device comprising at least one processor coupled to a memory device storing computer executable instructions, the at least one processor, upon executing the computer executable instructions, programmed to:
identify a static object based on the sensor data,
estimate a 3D radar velocity of the autonomous vehicle based on the sensor data, the 3D radar velocity expressed in a radar coordinate system,
compute a 3D vehicle velocity in a vehicle coordinate system based on a radar-to-vehicle orientation and the 3D radar velocity,
compare the 3D vehicle velocity to a longitudinal axis of the autonomous vehicle,
detect a misalignment of the radar sensor based on the comparison, and
control operation of the autonomous vehicle based on the detected misalignment.

9. The autonomous vehicle of claim 8, wherein the processor is programmed to detect the misalignment based on sensor data only from the radar sensor.

10. The autonomous vehicle of claim 8, wherein the processor is further programmed to detect the misalignment while the autonomous vehicle is in operation.

11. The autonomous vehicle of claim 8, wherein the processor is further programmed to transmit an indicator of the misalignment to a perception module of an autonomy computing system of the autonomous vehicle.

12. The autonomous vehicle of claim 8, wherein the processor is further programmed to:
determine the autonomous vehicle is not turning based on the trajectory; and
initiate the computation of the 3D vehicle velocity of the autonomous vehicle based on the determination.

13. The autonomous vehicle of claim 8, wherein the processor is further programmed to compute a confidence level of the detected misalignment.

14. The autonomous vehicle of claim 13, wherein the processor is further programmed to correct the misalignment in the sensor data based on an angle between the 3D vehicle velocity and the longitudinal axis based on the confidence level.

15. An autonomous vehicle comprising:
a misalignment determination computing device comprising at least one processor coupled to a memory device storing computer executable instructions, the at least one processor, upon executing the computer executable instructions, programmed to:
receive sensor data from a radar sensor disposed on the autonomous vehicle travelling along a trajectory,
identify a static object based on the sensor data,
estimate a 3D radar velocity of the autonomous vehicle based on the sensor data, the 3D radar velocity expressed in a radar coordinate system,
compute a 3D vehicle velocity in a vehicle coordinate system based on a radar-to-vehicle orientation and the 3D radar velocity,
compare the 3D vehicle velocity to a longitudinal axis of the autonomous vehicle,
detect a misalignment of the radar sensor based on the comparison, and
control the operation of the autonomous vehicle based on the detected misalignment.

16. The autonomous vehicle of claim 15, wherein the processor is further programmed to detect the misalignment based on sensor data only from the radar sensor.

17. The autonomous vehicle of claim 15, wherein the processor is further programmed to detect the misalignment while the autonomous vehicle is in operation.

18. The autonomous vehicle of claim 15, wherein the processor is further programmed to transmit an indicator of the misalignment to a perception module of the autonomy computing system.

19. The autonomous vehicle of claim 15, wherein the processor is further programmed to:
determine the autonomous vehicle is not turning based on the trajectory; and
initiate the compute of the 3D vehicle velocity based on the determination.

20. The autonomous vehicle of claim 15, wherein the processor is further programmed to correct the misalignment in the sensor data based on an angle between the 3D vehicle velocity and the longitudinal axis and based on a computed confidence level of the detected misalignment.
